(19) United States
(12) Patent Application Publication
(10) Pub. No.: US 2011/0239253 A1
(43) Pub. Date: Sep. 29, 2011

(54) CUSTOMIZABLE USER INTERACTION WITH INTERNET-DELIVERED TELEVISION PROGRAMMING

(76) Inventors: R. Michael Peters West, Colchester, VT (US); Robert Francis Shambro, Las Vegas, NV (US)

(21) Appl. No.: 13/045,440

(22) Filed: Mar. 10, 2011

Related U.S. Application Data
(60) Provisional application No. 61/312,382, filed on Mar. 10, 2010.
(60) Provisional application No. 61/312,409, filed on Mar. 10, 2010.
(60) Provisional application No. 61/312,431, filed on Mar. 10, 2010.
(60) Provisional application No. 61/312,459, filed on Mar. 10, 2010.
(60) Provisional application No. 61/312,473, filed on Mar. 10, 2010.

(51) Int. Cl. H04N 5/445

(52) U.S. Cl. 725/46

(57) ABSTRACT

An Internet-delivered television system facilitates enhanced viewer experiences by incorporating user-defined composite channels that include custom viewing schedules and content from multiple content sources. Additionally, customizable user interface elements for content delivered via a network may be provided to a user and may be arranged in an order according to a user-defined channel lineup customized according to any one or more of: user preference, time of day/day of week, user profile information, user viewing statistics, user community viewing statistics, sponsor or content provider preferences, user identity, parental control preferences, or other user-defined criteria, and/or are organized according to a user-defined channel numbering scheme. In some embodiments, the custom viewing schedule may be created by and/or managed by one or more users.

### RELATED APPLICATIONS

This application is a NONPROVISIONAL of, claims priority to, and incorporates by reference U.S. Provisional Patent Applications 61/312,382, 61/312,409, 61/312,431, 61/312,459 and 61/312,473, all of which were filed 10 Mar. 2010.

### FIELD OF THE INVENTION

The present invention relates to methods and systems for user interaction with Internet-delivered television programming.

### BACKGROUND

Broadcast television is a consumption-based activity. Users or viewers are expected to passively consume the content provided by broadcasters. More recently, forms of interactive television which permit limited forms of viewer feedback or on-demand consumption have been deployed. While these modest deployments improve upon the consumption model, television viewing remains a largely passive experience.

### SUMMARY

Systems, devices and methods for user interaction with Internet-delivered television programming are herein described. In some embodiments, this takes the form of generating a composite channel that includes a custom viewing schedule and content from multiple content sources delivered via a computer-based network. The custom viewing schedule may be a playlist and may be created by and/or managed by one or more users or by the system. In some embodiments, this takes the form of generating one or more system-defined composite channels that include custom viewing schedules and content from multiple content sources delivered via a computer-based network. When generated by the system, such custom viewing schedules or composite channels would be built and/or aggregated from content available on other channels and/or from other sources based on content related metadata or similar and/or user ratings of the content. Such custom viewing schedules or composite channels would be made available on the service to subscribers, either freely or for a subscription fee. Any revenues so generated would then be shared amongst the providers of the content delivered or made available in such custom viewing schedules or on such composite channels.

A composite channel creation menu through which a user is permitted to designate a custom viewing schedule and one or more content sources as being contributing content sources for the composite channel may be provided to a set-top box communicatively coupled to a display device. The custom viewing schedule may include content items selected from an electronic program guide (EPG). User selections for contribution to the composite channel, such as, for example, the custom viewing schedule, content attributes, and/or content sources may be received through the set-top box. The user selections may then be associated with a custom channel number for identifying the composite channel within a channel lineup presented via the EPG. The user selections and custom channel number association may also be saved.

In another embodiment, a composite channel that includes at least one custom viewing schedule and content from multiple content sources delivered via a computer-based network may be generated. In some embodiments, the custom viewing schedule and/or composite channel may be created by and/or managed by one or more users or by the system, or one or more servers therein.

The custom viewing schedule and one or more content items for the composite channel may be located on the basis of, for example, content attributes or metadata predetermined by a user and/or by the server. The content items may be hosted or provided by any of a number of custom viewing schedule sources and content sources. Each custom viewing schedule and content item may have one or more of the attributes or metadata associated therewith and the custom viewing schedule may include content items selected from an EPG and/or selected from one or more databases resident on, or available to, and made available by, one or more servers in the system. The custom viewing schedule and content items may then be aggregated as selections for contribution to the composite channel and the selections may be published within a composite channel of an EPG for a network delivered content service and/or may be made available by the server to subscribers on that service.

In yet another embodiment, customizable user interface elements for content delivered via a network may be provided to, for example, a user. Content choices representing at least one custom viewing schedule and programming and other content available via subscribed-to content providers in an EPG may be presented to, for example, the user. The content choices within the EPG may be arranged in an order according to a user-defined channel lineup customized according to any one or more of: user preference, time of day/day of week, user profile information, user viewing statistics, user community viewing statistics, sponsor or content provider preferences, user identity, parental control preferences, or other user-defined criteria, and/or are organized according to a user-defined channel numbering scheme, wherein the custom viewing schedule includes content items selected from the EPG.

In some embodiments, the custom viewing schedule may be created by the user and/or by the server based on known user preferences as a recommendation to the user. Content items for inclusion in the custom viewing schedule may be selected from an EPG presented to a user via a display device communicatively coupled to a set-top box. Identification information for selected content items may be aggregated into a custom viewing schedule for a viewer. The custom viewing schedule may control automated channel selections for the set-top box. The custom viewing schedule may then be saved, on the set-top box and/or the server, for later use by the set-top box in presenting or ensuring the recording of the selected content items in the custom viewing schedule. The custom viewing schedule created by either a user or the server can also be made available to other users (either all users or a subset of all users chosen by the first user) through distribution means made available on the service.

### BRIEF DESCRIPTION OF THE DRAWINGS

The present invention is illustrated by way of example, and not limitation, in the figures of the accompanying drawings, in which:

FIG. 1 illustrates an example of a network configured in accordance with an embodiment of the invention for delivering television content over the Internet;

FIG. 2 illustrates an example of a set-top box configured for use in a network such as that depicted in FIG. 1;

FIG. 3 illustrates an example of remapping of television channel lineups in accordance with embodiments of the present invention;

FIG. 4 illustrates an example of an on-screen channel guide including active television content delivered via a set-top box such as that shown in FIG. 2;

FIG. 5 illustrates a further example of an on-screen channel guide for an Internet-based television content delivery system in accordance with embodiments of the present invention;

FIG. 6 illustrates an example of a process for creating a custom viewing schedule in accordance with embodiments of the present invention;

FIG. 7 illustrates an example of a process for sharing audio-video clips among subscribers to television programming delivered via the Internet or other computer-based networks in accordance with an embodiment of the present invention;

FIG. 8 illustrates an example off process for generating a composite channel that includes content from various television providers and other sources delivered via the Internet or other computer-based networks in accordance with an embodiment of the present invention;

FIG. 9 illustrates an example of a process for inviting participants to a shared viewing experience in accordance with embodiments of the present invention; and

FIGS. 10A-10C illustrate examples of viewing modes for a shared viewing experience in accordance with embodiments of the present invention.

### DETAILED DESCRIPTION

Described herein are methods and systems for user interaction with Internet-delivered television programming. Examples include methods and systems for providing customizable user interface elements, including electronic program guides, for television programming delivered via the Internet or other computer-based networks or via conventional cable (i.e., hybrid fibre coax) or satellite television networks. In one embodiment, the customizable user interface is an electronic program guide that includes a customized channel lineup (i.e., the ordering of channels in a list). The channel lineup may be customized according to user preference, time of day/day of week, user profile information, user viewing statistics, user community viewing statistics, sponsor or content provider preferences, user identity (e.g., as determined based on user log-in or registration and/or biometric readings provided via a remote control or set-top box), parental control preferences, or other criteria. In addition, embodiments of the invention include electronic program guides organized according to customizable channel numbering schemes. Still further embodiments of the invention include electronic program guides that include displays of content from one or more television content providers. These and further embodiments of the invention are described below and those of ordinary skill in the art will recognize that the present invention finds applicability to content and/or services delivered to users by a conventional cable or satellite network as well as via the Internet.

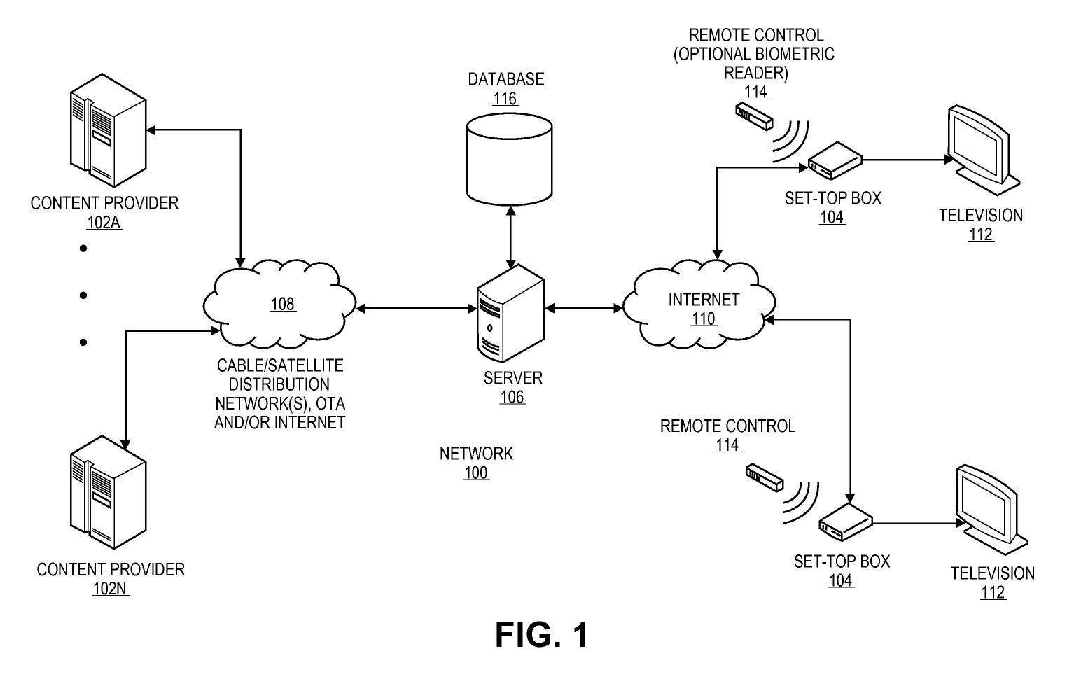

Referring first to FIG. 1, an example of a network 100 configured for delivery of television content via the Internet or other computer-based network in accordance with embodiments of the invention is shown. As indicated above, however, the present invention is equally applicable to other television content delivery means, including cable and/or satellite distribution means, and so the following description is intended only as an example of the environment within which the methods and systems that comprise the invention may be implemented. The television content is delivered from various service providers 102A-102N, preferably on a user-defined, à la carte basis, to one or more subscribers, each equipped with a set-top box 104. That is, subscribers to an Internet-delivered television service are each able select their own service offerings, i.e., each subscriber may select his/her own set of television channels instead of having to select prepackaged channel/content offerings designed by a cable, satellite or other service provider. In this way, the subscribers may choose any number of television channels, in any combination, and pay subscription fees solely according to their selections.

This à la carte service offering is made possible by collecting or channeling the television content from the many service providers 102A-102N at/through a server 106 (note, although only one server 106 is illustrated, it should be appreciated that this one server may represent many servers, arranged in central or distributed fashion, in order to accommodate a large subscriber base—for example, such servers may be organized as a central cloud and/or may be distributed geographically or logically to edges of a network in order to minimize service latencies; in either instance, various content may be replicated across the servers that make up the distribution network). Server 106 may receive the content via any of a number of means 108, including conventional cable or satellite television distribution means, over-the-air broadcast, or via one or more computer-based networks, such as the Internet. The content is delivered from server 106 to the various set-top boxes 104 via the Internet 110. Server 106 stores this content (either itself or in attached storage) and may distribute the content for retention on/by other servers within the network. The content is retained for a period of time (which may vary depending on the content, the content providers' wishes, the available storage space, the popularity of the content, etc.) allowing such stored content to be accessed by subscribers at a later time. In this way, the network may operate as an on-line digital video recorder. The television content includes television programming (e.g., both stored and live programming), Internet-based content (including subscriber-generated content), and metadata that includes information about the programming and other content (including, but not limited to, episode names, dates and times of broadcast, etc.).

Each set-top box is communicatively coupled to server 106 (e.g., via a local area network (LAN) using either a wired or wireless connection to a modem or similar equipment that couples the LAN to the Internet in order to exchange data therewith, and, in turn, delivers the content to an associated television or monitor 112 that is communicatively connected to the set-top box (e.g., via a wired or a wireless connection). Individual channel selection may be made via a wireless remote control 114 that is communicatively coupled to a respective set-top box. Selection may be via the electronic program guides discussed below, and/or via hard buttons or other user-manipulable selectors (rocker switches, touch screens, etc.) present on the remote control. The remote control may optionally be fitted with a biometric reader, such as a fingerprint reader, for use in identifying the user holding or operating the remote control. The use of biometric readings facilitated by such devices allows for the generation and presentation of customized electronic program guides for the user. Of course, user identity may be established in other ways, for example using a log-in process and/or using other biometric readings taken by sensors associated with the remote control and/or the set-top box (or even a separate computer system or appliance communicatively coupled to the set-top box).

Server 106 is also communicatively coupled to a database or other storage means 116. This database may be used to store subscriber information, such as subscriber profiles, subscriber channel selections, subscriber-customized electronic program guide preferences, copies of television content (for on-demand viewing, etc.), and other information. As noted above, server 106 (in some cases, together with other servers and associated data storage devices) retains content for a period of time, allowing it to be accessed by subscribers in an on-demand or time-shifted fashion. The subscriber channel selection information may include information regarding current channels subscribed to by a subscriber, gifted channels provided to others by a subscriber, one-time channel subscriptions for on-demand viewing, etc.

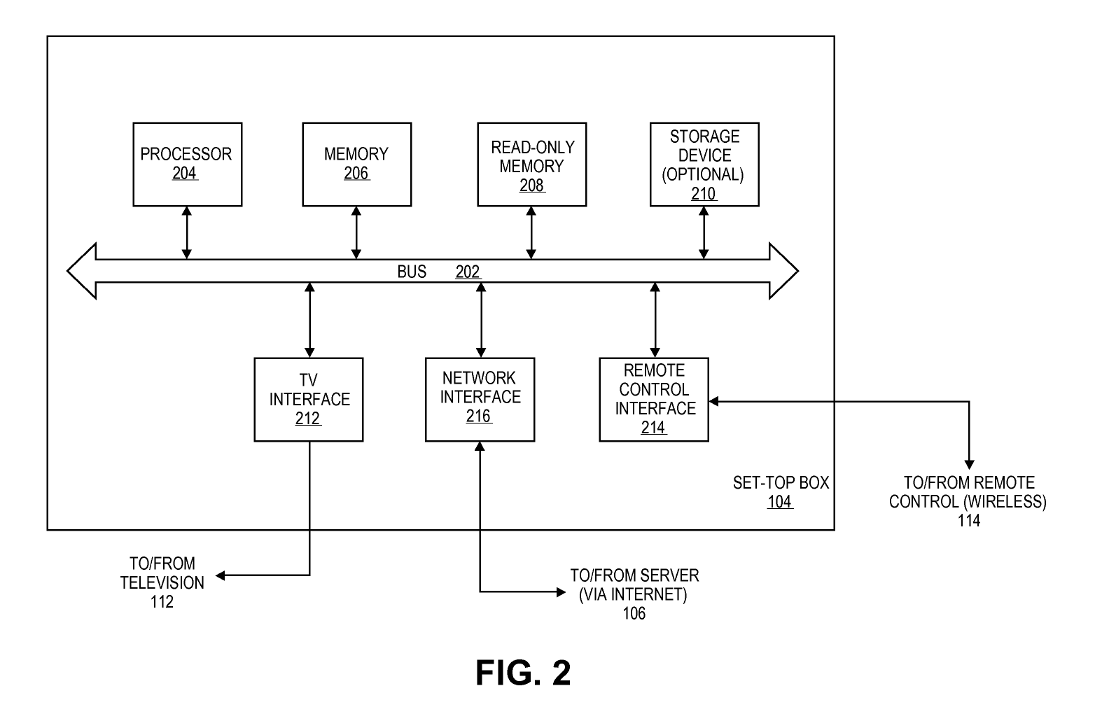

FIG. 2 illustrates features of a set-top box 104 in greater detail. Note that is intended only as an example of a set-top box configuration and is not intended to limit the scope of the present invention in any way. Many of the features and functions provided by the elements described below could be integrated on a single system-on-a-chip or could be distributed over more or fewer modules that are discussed herein. Therefore, the precise hardware configuration of the set-top box is not critical to the present invention. It should also be noted that the use of set-top box 104 devices in the network 100 in FIG. 1 is merely illustrative, in that it would be recognized by those familiar with, and/or skilled in, the art that the functions provided by a set-top box 104 could be integrated within, or distributed across, other or different components of the network 100. For example, modern consumer electronics devices such as televisions, optical disc players, DVRs, home theater systems and the like are available with “Internet Enabled” or “Internet Ready” capabilities. Such devices would integrate some or all of the functionality of a set-top box 104 and therefore potentially eliminate the need for such a set-top box 104. Likewise, it would be clear to those familiar with, and/or skilled in, the art that any reference to one or more set-top box devices in all descriptions herein is accordingly illustrative of any client device capable of performing such functions.

In the illustrated example, set-top box 104 includes a bus 202 or other communication mechanism for communicating information, and a processor 204 coupled with the bus 202 for processing information. The set-top box also includes a main memory 206, such as a random access memory (RAM) or other dynamic storage device, coupled to the bus 202 for storing information and instructions to be executed by processor 204. Main memory 206 also may be used for storing temporary variables or other intermediate information during execution of instructions to be executed by processor 204. Set-top box 104 further includes a read only memory (ROM) 208 or other static storage device coupled to the bus 202 for storing static information and instructions for the processor 204. An optional storage device 210, such as a magnetic disk or flash memory, may be provided and coupled to the bus 202 for storing (at least temporarily) television and/or electronic program guide (EPG) content and instructions (e.g., the operating system for the set-top box, user EPG preferences, etc.). If present, storage device 210 (which may, in some instances, be an external storage device or a combination of an internal and an external storage device) may facilitate the use of the set-top box as a digital video recorder (DVR).

According to one embodiment of the invention, the processor (or other application specific hardware) 204 executes sequences of instructions contained in main memory 206 in order to decode (or encode) the audio/video content for presentation via television 112 and produce the customized on-screen EPGs which may be overlaid or otherwise presented via the television 112. Such instructions may be read into main memory 206 from another computer-readable medium, such as storage device 210 or ROM 208. In alternative embodiments, hard-wired circuitry may be used in place of or in combination with computer software instructions to implement the invention. Thus, embodiments of the invention are not limited to any specific combination of hardware circuitry and software.

Set-top box 104 may be coupled to television 112 via a television interface 212. Television interface may correspond to any of a number of conventional interfaces such as a high definition multimedia interlace (HDMI) or other interface. An input device, such as the remote control 114, is communicatively coupled to the bus 202 for communicating information and command selections to the processor 204 via a remote control interface 214. Such an interface may be an infra-red (IR) or other interface. The input device should be configured to permit manipulation of an on-screen cursor along at least two axes, e.g., a first axis (e.g., x) and a second axis (e.g., y), allowing the device to specify positions in a two-dimensional plane.

Set-top box 104 also includes a network interface 216 coupled to the bus 202. Network interface 216 provides a two-way data communication path with server 106. For example, network interface 216 may be a wired or wireless local area network (LAN) interface to provide a data communication connection to a compatible LAN (such as a LAN that uses an IEEE 802.11a/b/g/n communication protocol). Set-top box 104 can send messages and receive data, including television content and EPG information, firmware updates, and other information through network interface 216.

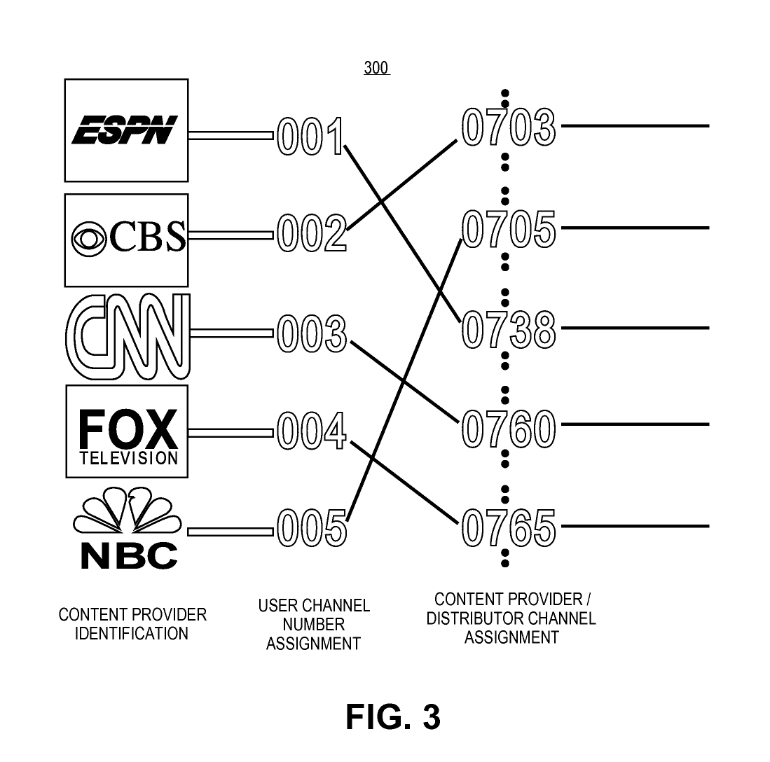

Referring now to FIG. 3, an example of a customized channel lineup 300 is illustrated. The customized channel lineup may be delivered by set-top box 104 (e.g., in response to user input via the remote control 114) to television 112 for presentation on-screen. Alternatively, or additionally, the customized channel lineup may be delivered by the server 106 via the network 110 and set-top box 104 (e.g., in response to user input via the remote control 114) to television 112 for presentation on-screen. In the illustrated example, the user has assigned channel number 003 to CNN, i.e., for convenience of the user, whereas the service provider considers CNN to be channel 0760. With this kind of reassignment, the user does not need to remember provider-designated channel numbers for the channels the user has subscribed to.

The customized channel lineup may be presented as part of an EPG which also includes information regarding the television programming available at a specified date and time, or it may be presented independently of such information. Further, the customized channel lineup may be presented with or without content provider identifiers, such as logos, etc. In place of such logo identifiers, simple text information may be presented. Usually, though not necessarily, the customized channel information will be provided in some form of grid or other structured layout, navigable by a user via the remote control.

As illustrated in the diagram, the customized channel lineup presents television channels in an order that is usually different from that which would result if only the television content provider channel mappings were used. The order is determined in any of a number of ways. For example, the order may be specified by a user and may remain invariant thereafter unless specifically changed by the user. Alternatively, the order may be determined by user identity, determined either through user input from the remote control or set-top box (e.g., as part of a log-in process) or through biometric readings from a biometric reader embedded in the remote control or set-top box. Of course, other forms of active or passive identification could also be used (e.g., the presence or absence of a fob detectable by the remote control or set-top box, or other form of identification). For example if a fingerprint scanner is included in the remote control, the user may be identified via a fingerprint scan and a channel lineup according to that user's preferences may be presented. This may also be used in combination with parental controls so that if the biometric reading is associated with a minor or other identifiable user (e.g., based on a pre-established profile), only a predetermined list of channels (which may exclude channels deemed to be unsuitable for the identified user) may be presented in the channel lineup.

The channel lineup may be further ordered based on time-of-day and/or day-of-week, user profile information (e.g., which may include a predetermined channel lineup preference), user viewing statistics (e.g., as collected over time through monitoring of the user's viewing habits by the set-top box or the server), user community viewing statistics (e.g., as promulgated by the server 106 for a group of users with which the subject user identifies or subscribes to), sponsor or content provider preferences (e.g., television content providers or advertisers may pay premiums to the operator of network 100 to have their channel listings appear higher in the ordering), or other criteria.

In general, channel ordering may be based on any sortable categorization, whether that categorization is static or is somehow time-dependent. Note that in this regard, the date and time of content broadcast is usually a static property, applicable to a static category; however, the ‘countdown’ to an impending broadcast of a particular program is a time-dependent property, since the nature and/or order of information presented depends on when that information is presented. Accordingly, as the time to broadcast of a program approaches, its relative position within an EPG may change. Further examples of ordering are alphabetical (or reverse-alphabetical) by channel name (i.e., A-Z or Z-A), recently viewed (e.g., by time, most-least recent or least-most recent), recently broadcast/uploaded (i.e., date of initial availability from server 106), alphabetical (or reverse alphabetical) by content group, series names (for episodic content), viewing frequency (e.g., most/least often watched), or viewing time (e.g., most/least time spent watching), etc.

The channel lineup may be presented with or without channel numbers. If presented with numbers, this facilitates the use of hard buttons or other user-manipulable elements of the remote control for channel selection. If presented without channel numbers, then the channel lineup may include only the content provider identification information or the content identification information (e.g., the name of the program or event and its associated time) and selection may require the use of the remote control to position a cursor over the desired channel/program in order to make a selection.

In some instances, the position in the channel lineup may correspond to the remote control hard button. For example the channel appearing in the top-most position in the channel lineup may correspond to a hard button labeled “1” on the remote control, the next channel in the lineup to a hard-button labeled “2”, and so on. This, in effect, forms a “speed dial” for the user's television viewing. This mapping may vary over time/day, according to the user's preferences. Thus, the present invention provides both customized ordering of channels in an EPG (i.e., a customized presentation of the channels in a list regardless of the channel number assigned to each channel or associated with each channel by the service provider), as well as a customized channel numbering for each channel that is independent of the content provider's numbering scheme. Numbering schemes and/or lineup positions may vary and be determined according to any of the above-Mentioned or similar or user-defined criteria.

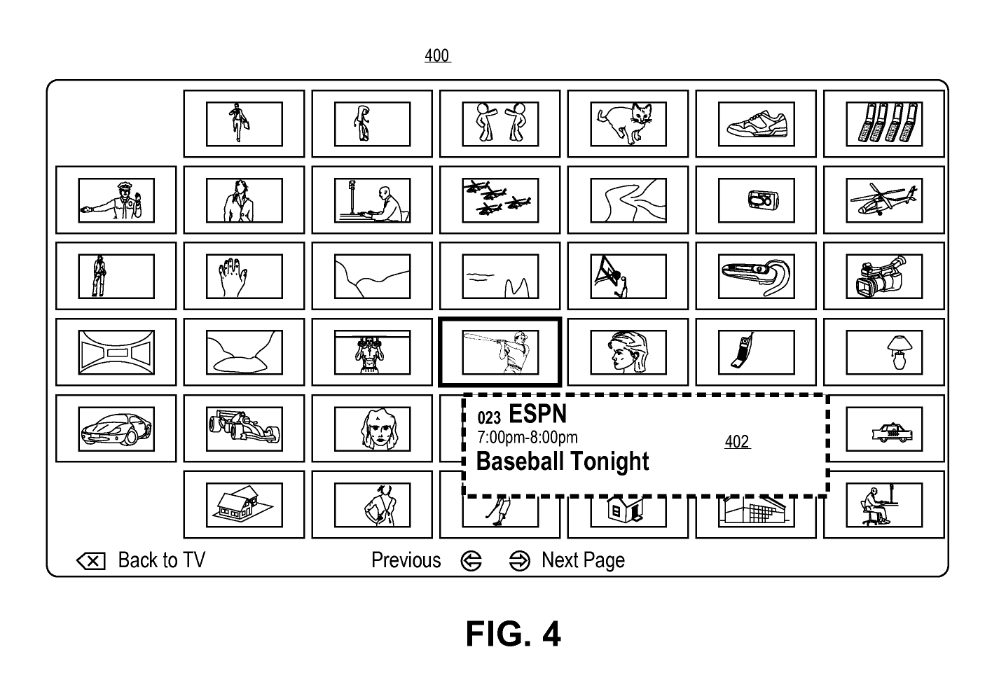

Referring to FIG. 4, a further example of an EPG configured in accordance with the present invention is illustrated. In this example, instead of text information for the program listings, channel feeds from the various channels subscribed to by the user are presented. In this example, still shots (captured from each channel at or about the time the user initiated the display of the EPG) are presented, but in other instances, bandwidth permitting, moving images may be presented. Or, the EPG may display still images for all but a selected channel and display moving images for a selected channel (e.g. as indicated by positioning of an on-screen cursor, which responds to commands input via the remote control). As shown in the illustration, this channel-based EPG 400 may also include metadata 402 regarding a selected channel. This metadata may describe the channel (by name of content provider, logo, etc., as well as the program presently being presented on the selected channel. As indicated, the selected channel may also be displayed as moving images (presented at some fraction of the ordinary viewing frame rate and size), rather than still, images. The screens displayed in EPG 400 may be scaled down versions of still images, captured television content, or may simply be channel logos or other identifiers, which are replaced with the still or moving images when selected via the on-screen cursor. In some instances, the still images may be replaced over time (e.g., according to a periodic schedule such as once per minute or other update rate, or to another schedule that accommodates current bandwidth conditions for the communicative coupling of the set-top box to the server) with new captures from the associated television channel or other content (e.g., the on-screen guide is not limited to presenting television content and may also show captures from web sites or other content sources which the user has mapped into his/her channel list). A suitable number of channels may be presented via EPG 400 to permit viewing convenience, which may be determined by, and configured at, the preference of the viewer. If there are more channels available than are desired to be presented on a single screen, means for scrolling or otherwise displaying those other channels (e.g., at the expense of currently displayed channels) are provided. Thus a page-by-page view and/or scrolling list of channel content may be provided. Pages and/or channels may scroll or be displaced horizontally or vertically, or in some instances using other transitions (such as a dissolve or other artifice) in order to provide the viewer with a sense of transitioning through the various channels.

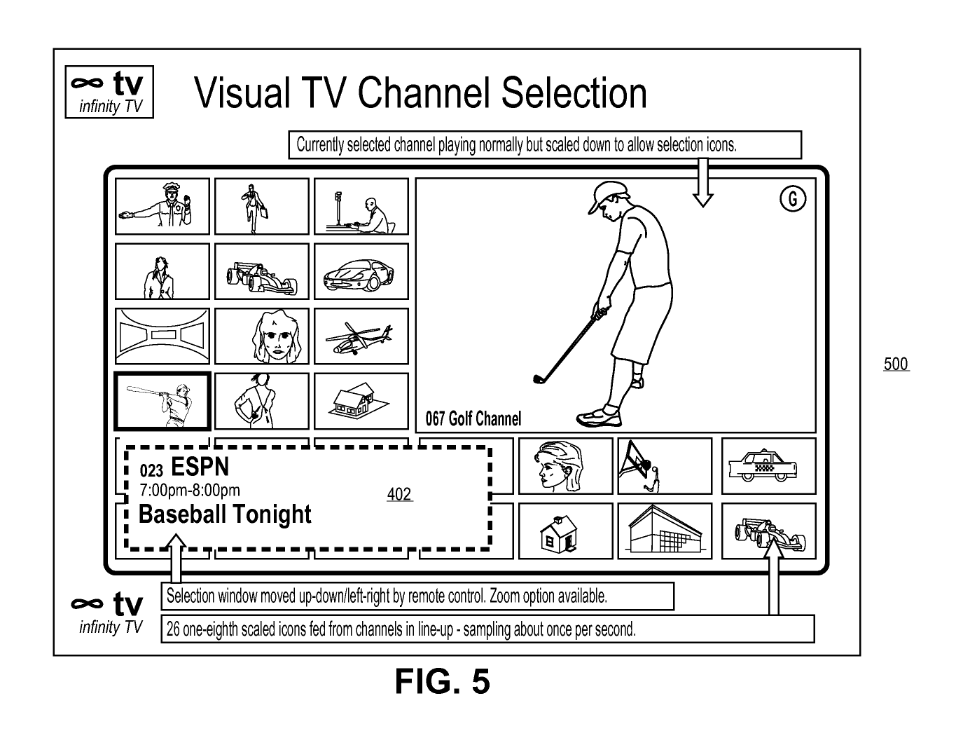

Referring to FIG. 5, a partial screen channel selection guide is shown. In this EPG 500, a window is provided for presentation of the content from the currently viewed channel, while content from other channels (stills or moving images in the fashion discussed above) is presented around the perimeter of that window. This allows the viewer to continue viewing the currently selected channel while deciding whether or not to change channels. As before, the on-screen cursor may be used to highlight potential new channel selections (e.g., causing the content of that channel to be displayed as moving images or otherwise) through manipulation of the remote control.

In some embodiments, the channel selection options displayed within EPG 500 (or any of the other EPGs described herein) may be determined according to the content and/or context of the channel presently being viewed. For example, if the viewer is presently watching a program on the Golf Channel, and so may be predisposed to watch sports programming, the other channels displayed in the EPG (e.g., in prominent positions therein) may also be channels presently carrying sports content. In some instances, this feature may only be activated if the user selects a “similar content mode” from the remote control.

In like fashion, users may be provided the ability to designate custom channel groups. These may be channels having similar content (sports, news, etc.) or may correspond to some other user-desired grouping. Channel hierarchies may be designated within these groupings and such groupings (or other content categorizations) could be shared among users via social networking facilities provided by the service provider operating network 100.

In addition to allowing users to renumber channels, the present invention permits viewers to label channel names/designators, as desired. For example. CNN Headline News might be designated by the content provider or distributor as “CNN-H” or by its full name, but in accordance with the present invention, a user could rename this channel as “News 1” or other label. The user might also have the option of defining their own short mnemonics (e.g. “CNN-FIN”) for the channel which would be used when they want minimum screen clutter during navigation amongst channels while watching another channel. Obviously this would be another sort/ordering/priority category. If a channel is unnamed by the user, then one would default to names given for content providers (e.g. CNN, ESPN, . . . ). As with other ordering and categorization choices, multiple individuals within a household could generate their own customizations and or share them with others in the home and/or with friends across the network. Alternatively, or additionally, such customizations can be provided for a group of users within a home (e.g., for an entire family) or for a group of users distributed remotely across the network. Such group customizations may be created manually by one or more users in the group and/or may be created automatically by the service by operating on, and aggregating, customizations for individual users or groups of users.

As indicated above, channel lineups may also be presented as text rather than icons. This would allow the EPG more screen space to present other information, or to present more than one ordering or categorization simultaneously.

Thus, customizable user interface elements, including electronic program guides, for television programming delivered via the Internet or other computer-based networks have been described. The user mappings described herein may be stored locally on a set-top box and/or at a remote server. When stored on a server, the user channel mappings could be recalled through any compatible set-top box via a log-in or other user identification procedure. In this way, the user's customized EPGs and other elements can be made “transportable” within the Internet-based television content delivery system described herein. Further, storing the user-related preferences on the server provides a back-up in the event this information is lost on the set-top box due to user error or malfunction.

In accordance with embodiments of the present invention, channel lineups presented for selection on display device such as a television are customizable by the user (a.k.a. subscriber, viewer, client, etc.) in that the user can select a custom channel number for any/all channels he/she has subscribed to rather than having to use numbers assigned by a service provider. The user is free to change his/her channel numbering scheme at any time. Within a household different viewers can have their own individual channel numbering/ordering schemes or can share such schemes with others in the household and these can be saved as part of a viewer (or group of viewers) profile (e.g., at the set-top box, the server or both). When a channel lineup is presented for selection of channel, e.g., via an EPG, the user can elect to have the channels displayed in the numeric order (according to the user's numbering scheme) or in another order according to any of the above-mentioned criteria. For example, a channel lineup may be displayed in an order based on usage statistics (either for the individual user consumer or for a group to which the user belongs). Alternatively, channels may be ordered based on viewing habits, such as most/least frequently viewed channel, perhaps as modulated according to time-of-day/day-of-week, last viewed channels (in order of when they were last viewed), etc. Accordingly, the channel display order may vary over time according to the user's viewing habits/preferences. Users may be provided the option to designate favorite programs (and have those programs appear towards the top of a channel lineup at the appropriate date/time, even if these choices contradict actual viewing patterns. By gathering such information (favorite programs and actual viewing habits, etc.), the set-top box and/or the server may be able to provide suggested viewing choices towards the top of the channel lineup and notify users when a favorite program is about to commence (e.g., either via an on-screen message or an out-of-band communication such as an e-mail or text message or the like). In accordance with the invention, channel lineups may be displayed in desired orders as icons for each channel, preferably with multiple icons per screen or page, and/or as actual content captured from the available channels.

In addition to the above, in embodiments of the invention the channel lineup may be presented as a table or two-dimensional matrix with categories arrayed in one dimension (e.g., horizontally) and channels within those categories arrayed in the other dimension (e.g., vertically). Such a channel lineup provides the user with the ability to scroll (e.g., to manipulate an on-screen cursor using the remote control or other interface device) in the first dimensional across and amongst categories and in the second dimension through and amongst channels within a particular category. In some cases, when the user scrolls through channels in a category and reaches (or approaches) an end of a currently displayed column, then only the channels within that category scroll to reveal channels not already presented on the screen. That is, the column, but not the entire matrix, scrolls to reveal additional choices.

The categories within such a matrix can be defined according to metadata provided by the content providers or according to usage statistics or similar information regarding the viewer/community of viewer habits or preferences, or both. Similarly, channels can be assigned to categories according to such metadata, usage statistics or similar information regarding the viewer/community of viewer habits or preferences, or both/any of the foregoing. The ordering of the categories can be based on any user-defined or predetermined criteria, for example, alphabetical or reverse alphabetical, usage statistics, or other criteria specified actively or developed passively or imported, etc. Multiple ordering methodologies could be used within the same channel lineup (e.g., a sports category as well as a most watched category could be displayed on screen at same time) such that one or more channels or content items might appear multiple times simultaneously on the screen if they fit into multiple categories.

As with category ordering, the ordering of channels within categories can be based on any of the above-described criteria and individual channels may appear in one or more categories. Two or more categories of channels (even if somewhat similar to one another) could be displayed at same time (e.g., a sports category which listed channels alphabetically and sports category which listed channels by their viewing frequency could be presented at the same time).

Within the matrix, those channel icons displayed within their respective categories may be determined according to currently available programming (e.g., a network that is televising a sporting event may appear at one time in a sports category and may later appear in a movie category when a movie is being televised) or future programming when the user scrolls ahead in time. This gives a “what's on now” vs. “what's on later” dimension to the channel lineup and channels may cross category boundaries over such different time periods, or channels may be newly instantiated into, duplicated into or removed from multiple categories over such time periods. In some instances, when the user highlights a specific channel and invokes an appropriate command, the EPG may be presented according to a “what's on later” format with multiple categories encompassed within the listings.

The ability to scroll a cursor in two dimensions is not limited to categories and channels. Among the various dimensional attributes that may be assigned to the EPG are: categories, channels, time (past, present and future), and users (recall that different users even within a single household may have different lineups). In addition, users may be permitted to construct a playlist or custom viewing schedule for viewing and the playlist may be constructed from selections made via the EPG. In this way, an entire day's, week's, or other time period's viewing could be pre-planned so that the set-top box would automatically tune to the appropriate channel at the appropriate time.

Also described herein are methods and systems for creating playlists for television programming delivered via the Internet or other computer-based networks or via conventional cable (i.e., hybrid fibre coax) or satellite television networks. In one embodiment, the playlists are created from an electronic program guide (EPG), which may, but need not, include customized channel lineups. Where custom channel lineups are used, the customization may be made according to user preference, time of day/day of week, user profile information, user viewing statistics, user community viewing statistics, sponsor or content provider preferences, user identity (e.g., as determined based on user log-in or registration and/or biometric readings provided via a remote control or set-top box), parental control preferences, or other criteria. In addition, embodiments of the invention provide for sharing playlists with others and/or subscribing to playlists of others. Still further embodiments of the invention include “pushed” playlists generated by a service provider or a content/channel sponsor. Such playlists may include programming that a sponsor or service provider wishes to have subscribers opt in to viewing (perhaps in exchange for reduced subscription fees or other consideration). These and further embodiments of the invention are described below.

As used herein, the term playlist means a defined list of audio/video (or just audio or just video) content items (e.g., television programs, user-generated content, Internet-based content, etc.) selected to run either in sequence or, if a shuffle playlist function is selected, in a random or pseudorandom order. Playlists may comprise content items of a similar genre, from a common channel or content provider, from a common type of channel or content provider, or other user-defined or provider-defined criteria. Some playlists may include content recommendations, ratings and/or reviews. In accordance with embodiments of the invention, users are able to create and share annotated playlists, giving subscribers to those playlists the option to read contextual information or reviewer comments about each content item while viewing or in advance of or after viewing same. For example, the annotations may include a user's thoughts about why the content items are grouped in a playlist or comments added after the user has viewed a content item, reflecting the user's thoughts and feelings about the program. In other cases, the sharing may be restricted to just the playlist itself, without any annotations.

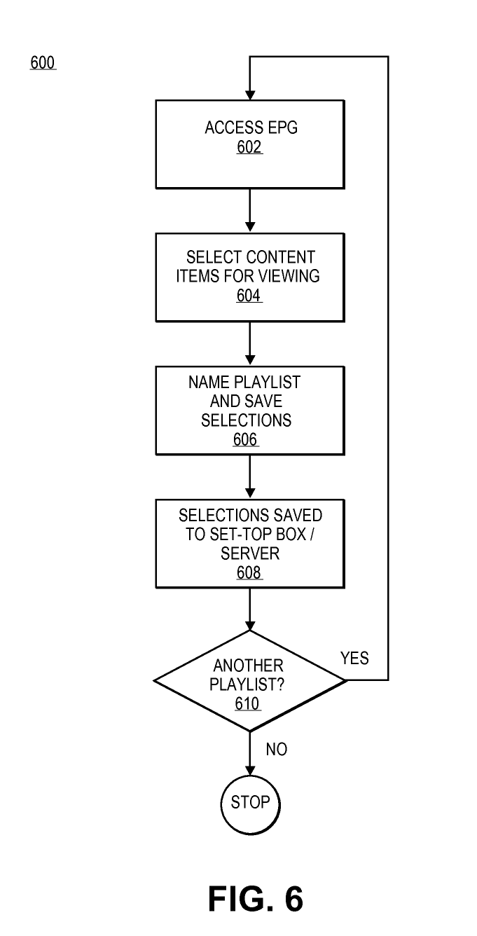

Referring now to FIG. 6, a process 600 for creating a playlist is shown (note, in various embodiments the sequence of events described below may be performed in a different order). In this example, a playlist is created by a viewer by first displaying an on-screen EPG 602. The EPG may be displayed in response to user input received at the set-top box via the remote control. As indicated above, the EPG may, but need not necessarily, include a customized channel line-up. Where present, the customized channel line-up identifies channels according to user-assigned channel numbers and/or used defined attributes (e.g., which attributes categorize the programs and other content items available for viewing). The EPG may also include information regarding the programming available at a specified date and time, or it may be presented independently of such information. Further, the channel line-up may be presented with or without content provider identifiers, such as logos, etc. Usually, though not necessarily, the EPG information will be provided in some form of grid or other structured layout, navigable on-screen by the user operating the remote control.

Once the EPG has been displayed, the user may select content items for viewing 604. This may be done by highlighting (using the on-screen cursor) desired programs for viewing. In the event two or more programs overlap in time, one or more of the programs may be recorded (at the set top box or the server) for later playback as part of the playlist. The selection of content items may include selections over several time periods, channels, content categories, etc. There need not be time continuity between selections. That is, the user may leave unallocated time periods in the playlist, which may be filled by time shifted playback of other selected content items or designated “free viewing” during which no previously selected content item is presented.

When the user has completed the playlist selections (which may include any number of such selections), the user indicates same using an appropriate command from the remote control. In response, the user is afforded an opportunity to name the playlist and save it 606. If the remote control is equipped with a hard keyboard, it may be used to provide the playlist name: otherwise, a soft keyboard may be provided on the television screen for the user's use.

The playlist selections may be saved at the set-top box level, the server level, or both 608. When the playlist has been saved, the user is given the option to create another playlist 610 or quit the process.

With the EPG and playlist features made available by the present invention, viewers can plan and organize their viewing schedules ahead of the actual broadcast of programming. Once engaged (either automatically or in response to user input), the designated playlist will be presented either in sequence or in a shuffle fashion. Users are freed from having to change channels or remember what time/date their desired programs are being broadcast. Playlists may be made periodic, so that, for example, each day of the week may have its own playlist of favorite programs which the viewer watches. Of course, viewers may retain the ability to deviate from a playlist and watch other programming (in which case the playlist programs may, in some instances, be recorded for later viewing). Likewise, if multiple programs for one or more playlists overlap in time, the programs may be recorded for time shifted playback (either within the context of a playlist or not).

In the case of episodic programs, viewers may create a playlist that plays episodes in sequence so that story lines are preserved. This may be true regardless of where in a series a viewer decides to create the associated playlist. Because content is stored in database 116, past episodes of series may be available to accommodate even late-created (from the standpoint of a series beginning) playlists. Episodic playlists may encompass a season's worth of episodes or may span a longer period of time if sufficient storage space is available. Note that in the ordinary circumstance, new episodes would not be available for play prior to their respective first broadcast.

Playlists may be stored to the set-top box and/or the server (e.g., in conjunction with a user's account information) and may be updated and edited at any time. When stored on a server, the playlists can be recalled through any compatible set-top box via a log-in or other user identification procedure. In this way, the user's playlists can be made “transportable” within the Internet-based television content delivery system described herein. Further, storing the user-related preferences on the server provides a back-up in the event this information is lost on the set-top box due to user error or malfunction.

A user may have any number of playlists and playlists that can be shared amongst other users (e.g. as emails, instant messages, or other in-system messages). Users can “opt in” to playlists created by third parties. In this way, friends can watch one another's favorite programs and users can also watch programs that appear on celebrities' playlists and the like. Content providers and/or sponsors may also create and share playlists for users. These playlists may be subscribed to in either a push or pull format. That is, the playlists may be published to a user's account (e.g., if a user agrees to receive same), or they may be posted to a common resource from which a user may elect to subscribe to the playlist. Subscribing to a playlist may involve additional subscription fees, but this is not necessarily so. By subscribing to a playlist, the user will be provided content items appearing on the playlist at the times and dates specified therein. Playlists may also be shared and/or published by community groups (e.g., communities of users), church groups, sporting teams, educational institutions, or any other group to promote content appealing to that group. Further, suggested playlists may be automatically created (e.g., by computer resources in network 100) as a service for individual users based on previously observed user viewing habits or other demographic information. Such playlists may be created by server 106 or other instrumentality with access to the user profile or demographic information.

Thus, methods and systems for creating and distributing playlists for television programming delivered via the Internet or other computer-based networks have been described.

Further described herein are methods and systems for sharing video audio-video clips among subscribers to television delivered via the Internet or other computer-based networks or via conventional cable (i.e., hybrid fiber coax) or satellite television networks. The present delivery system for television programming provides opportunities for creating and leveraging user communities. Such communities may be developed along any of several lines, for example, by allowing subscribers to identify their friends or contacts, by allowing subscribers to upload their address books and using the entries therein, by creating communities of users that watch certain television programs, genres of programs, actors and/or directors, etc. Further, because the set-top boxes 104 provide two way communication with the server 106, an in-system messaging platform may be deployed across these components to allow for messaging between different subscribers via the set-top boxes.

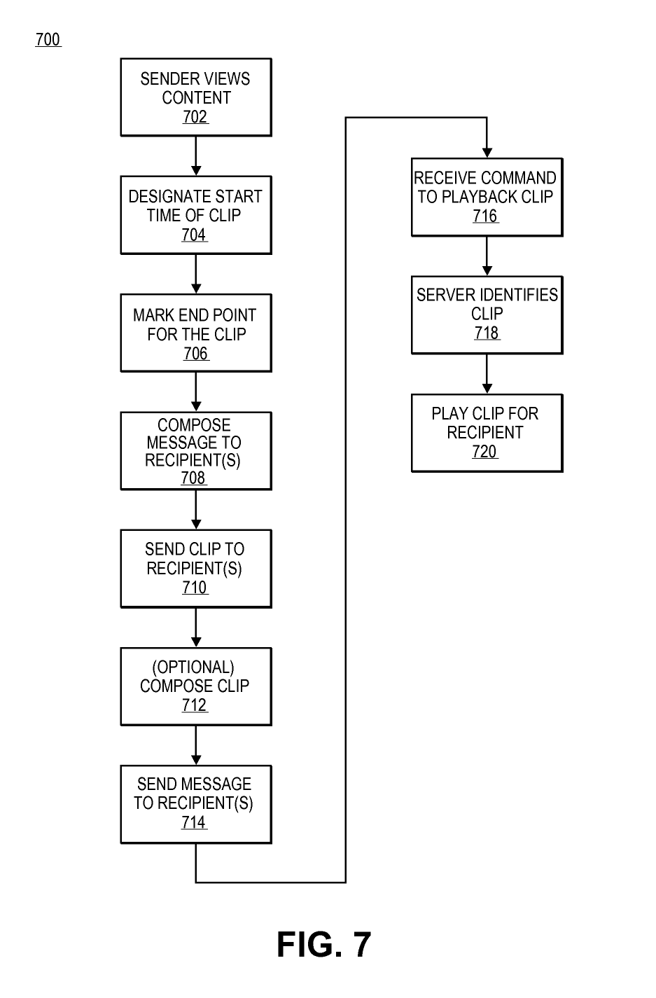

Referring now to FIG. 7, one such form of messaging may involve the inter-subscriber exchange of video audio-video clips (e.g., selected segments of content from television programs, movies and the like), without having to actually send the video content itself between set-top boxes. In the past, when friends wanted to share video content, they either had to share entire audio/video files (e.g., via email or other means) or share links that pointed to locations where such files could be found (e.g., uniform resource locators (URLs) that pointed to web sites where the video content of interest was hosted). Neither is an efficient means of sharing video content. In the case where entire files had to be shared, the size of such files is often more than can be conveniently handled by some email inboxes. Further, the sharing of content in this fashion may be an infringement of intellectual property rights of others. In the case of sharing URLs that direct a recipient to a web site or other location where content may be hosted, there is always the possibility that the URL will no longer be active, or the content may have been removed by the time the recipient tries to view it.

Overcoming these kinds of limitations, the present invention provides for sharing of video content by passing audio-video clip information from a sender's set-top box to the server, where it can be used to prepare an audio-video clip. The server, in turn, can pass a message to the intended recipient of the audio-video clip and then play back the audio-video clip at the request of the recipient (e.g., on a platform, such as a set-top box/or other instrumentality associated with or designated by the recipient). The video content itself need not be delivered from the sender's set-top box to the recipient's set-top box, nor does the recipient need to rely upon potentially outdated directions to the audio-video clip in order to view it.

As shown in FIG. 7, a method 700 of sharing video audio-video clips begins, at 702, with the sender viewing content on his/her television. The content is provided via the system described above through a set-top box 104. The viewer is a subscriber to the content (e.g., to the television channel or network over which the content is being provided).

If this is the first time the content is being provided from server 106, the content is stored by the server (e.g., in database 116). Alternatively, if the content has been previously stored by server 106, it may be being played back as part of a video-on-demand request or a time-shifted playback requested by the subscriber (e.g., in a server-based digital video recorder embodiment of the present system). In either instance, if the viewer wishes to send an audio-video clip of the content to his/her friend, the process is straightforward.

As the viewer is watching, he/she can designate the start time of an audio-video clip to be sent to the recipient(s) 704. In some cases, this may involve the viewer rewinding the playback to a point at which he/she intends the audio-video clip to begin. Such rewinding (as well as other trick modes) may be implemented either at the set-top box (e.g., by providing temporary storage of the content being viewed at the set-top box) or at the server 106. In either case, the start index of the video audio-video clip may be marked (e.g., as a time code or other indicator) by the viewer using an appropriate control from the remote control or similar means (e.g., set-top box controls or out-of-band controls from a computer system networked with the set-top box, etc.).

Next, the viewer allows the audio-video clip to play (or fast forwards) to a desired end point for the audio-video clip 706. Similar to the marking of the start index, the end index may be indicated via an appropriate control from the remote control or other means. The start and end indices may be stored by the set-top box until the complete message is ready to be sent, or they may be stored at the server (e.g., associated with the user's account or profile).

In either event, the viewer is then afforded an opportunity to compose a message to the recipient(s) 708. This may be done immediately after marking the end point of the audio-video clip or may be done at a later time convenient to the viewer. For example, the viewer may want to designate several audio-video clips out of the same program and so may do as he/she is watching the program and then afterwards compose a composite message for the recipient(s) that covers all of the various audio-video clips. The message may be composed using a keyboard which is part of the remote control, or is a separate keyboard, or is a soft keyboard that is brought up on-screen and used by manipulating the remote control or other means.

Once the message has been composed, the user sends the audio-video clip message to the recipient(s) by executing an appropriate command via the remote control 710 or similar means. The recipient(s) may be selected from an address book or other contact list, much in the same fashion as emails are customarily addressed. The address list may be accessible, from, for example, data stored in set-top box 104, on server 106, or elsewhere, via an on-screen menu using the remote control. Optionally, the sender may be allowed the opportunity to preview the audio-video clip prior to sending it, in case further edits or message comments need to be made.

When the audio-video clip is sent to the recipient(s), no audio/video information is transferred from the viewer's set-top box. Instead, the set-top box sends only the text of the message, along with identifying information for the subject audio/video content (of which the intended audio-video clip is a component), and the start and end indices for the subject audio-video clip to server 106.

At the server, the audio-video clip may be composed at this time 712. For example, the audio-video clip may be developed based on the start and stop indices and stored awaiting playback for the recipient(s). Alternatively, the audio-video clip itself need not be composed, but the program from which the audio-video clip is taken may be marked so that it is not deleted until the audio-video clips have been viewed by the recipient(s). Or, in some instances, the various accounts of the recipient(s) may simply be updated to reflect the fact that audio-video clips have been sent and audio-video clip generation may await response by the recipient(s).

In any event, the server 106 sends the message from the original viewer to the recipient(s) 714. Hereafter, it will be assumed that only one recipient is involved, but the processes discussed herein are applicable to audio-video clips sent to any number of recipients. In sending the message, the server sends the text of the message composed by the viewer, but need not send the start and stop indices. Instead, the server may include with the message some information about the program from which the audio-video clip was taken so that the recipient can determine whether or not he/she wishes to view the audio-video clip and when.

The message may be provided to the recipient immediately, via an on-screen notification through the recipient's set-top box, or may simply be indicated in an electronic mailbox accessible by the recipient. In the latter case, the recipient may be notified of the availability of a new message in his/her mailbox. The electronic mailbox may exist on the server or the recipient's set-top box, or both.

At some point, after reading the message the recipient will instruct the server to play back the audio-video clip 716. This may be done through an appropriate command via the remote control, for example by selecting an on-screen graphical element that results in a playback command being passed to the server. The instruction may take any of several forms and may include information that allows the server to identify the original audio-video clip parameters, such as the program identification, the start index and the end index. For example, each in-system audio-video clip message may have a unique identifier that is passed back to the server when a recipient instructs playback of an audio-video clip. Using this identifier, the server can recall either the previously stored audio-video clip, or can recall the original message from the sender to obtain that information, or other information sufficient to allow the server to identify the subject program and the start and stop indices for the audio-video clip 718.

Once the server has identified the audio-video clip, the server plays the audio-video clip for the recipient 720. This may involve playing a previously composed audio-video clip, or simply playing the designated portion of the previously stored program from the audio-video clip start index to the audio-video clip end index. Either way, the subject audio-video clip is played for the recipient. If multiple audio-video clips are involved, they may be played back serially one after the other, or may be played back only in response to individual commands sent by the recipient.

Many variations, refinements, and optimizations of the above-described process may be practiced in accordance with the present invention. For example, the marking of start and stop indices may be performed using single button operations by a viewer. That is, designated hard or soft buttons on the remote control may be invoked in order to perform the audio-video clip selection operations. Alternatively, or in addition, the user may be afforded an opportunity to select start and stop indexes from a graphical representation of the content as a timeline or series of frames presented on the television (e.g., in the fashion of a video editor) using an on-screen cursor or similar tool.

Further, in some instances, both the sender and the recipient need to be subscribers to the content provider before the recipient will be provided access to the audio-video clip. In other embodiments, however, the sender may be permitted to purchase rights to the audio-video clip for the recipient. Or, the sender may purchase a “audio-video clip right” on his/her own account that allows the sending of audio-video clips to recipients that are not subscribers to the particular content provider from which an audio-video clip is obtained. In still further instantiations, subscribers may have general “audio-video clip accounts” that can be debited whenever they receive and view audio-video clips from content providers to which they do not subscribe. In still other cases, audio-video clips may be provided free of charge in exchange for the recipient viewing advertisements or the like. The server 106, or a separate billing server (not shown) is configured to ensure that the appropriate charges are levied and collected in conjunction with the exchange of audio-video clips in the present system.

In some instances, as an aspect of the social network established among users of the present system, server 106 may maintain audio-video clip ratings, which are indicative of the popularity of audio-video clips. Such popularity may be measured, in one example, by the number of times audio-video clips are forwarded between users (in the fashion of chain letters or the like). As the number of such forwardings increases, audio-video clip popularity ratings may be increased. Such ratings may be maintained in billboard fashion at the server, available for all users to see. As a result, users may view audio-video clips (but not the messages accompanying audio-video clips unless permitted by the message sender) that had not necessarily been directed to them. The same account rules regarding subscriptions and the like would have to be observed. In addition, ratings may be assigned by a user at the time an audio-video clip is created, and also by a recipient after an audio-video clip has been viewed. These statistics too could be aggregated and averaged, and provided for use/review by others.

Audio-video clips may also be aggregated, either by individual users or by the server 106, to create composite audio-video clips. The composites may be from a single program, or from multiple programs that share one or more common traits, or that are “favorites” of a particular user or group of users. Audio-video clips, identified and generated as described herein, may also be included in playlists that have been described above. Audio-video clip ratings may be combined with program and/or content provider ratings to form aggregate ratings of programs, networks, etc. Audio-video clip libraries may be maintained to allow users to browse audio-video clips compiled by well-known users in a particular community or as promotional devices.

In order to ensure that intellectual property rights are respected, at the time a user creates an audio-video clip and designates recipients, the server 106 may consult its database 116 and determine whether or not those recipients have sufficient subscription, rights to view the audio-video clip. If not, the user creating the audio-video clip may be so advised, and may also be prompted to purchase such rights for the recipient (e.g., as a gift), or to designate the use of a low resolution version of the audio-video clip (or other format) which does not require subscription rights or has less expensive subscription rights. Alternatively, or in addition, the recipients may be notified that audio-video clips are awaiting their review but that subscription rights or other fees (e.g., one-time fees, day passes, etc.) are required in order to view the audio-video clips (or high resolution or other versions thereof).

Thus, methods and systems for sharing video audio-video clips among subscribers to television programming delivered via the Internet or other computer-based networks have been described. As discussed above, the present invention facilitates a service and community where users can extract portions (audio-video clips) of audio/video programming to share with one another, along with recommendations and comments regarding those audio-video clips. The recommendations and/or comments take the form of a small text message to which the audio-video clip attributes are appended. The messages may be shared with designated (by the original viewer) community members or could be made accessible to all (or a designated group or groups of) the community via a bulletin board or similar means. Importantly, only community members who have rights (by subscription or otherwise, e.g., previously or subsequently purchased/obtained) to access the audio-video clips are able to view same. In some instances, portions of audio-video clips (or low resolution versions of audio-video clips) may be viewable by non-subscribers, as an enticement for those individuals to become subscribers.

In some cases, the messages accompanying the audio-video clips may include one or more still images taken from the audio-video clips so as to indicate the nature thereof. In the case of multiple images, they may be played in serial fashion to emulate a moving picture.

As indicated, senders and recipients can assign ratings to audio-video clips. The ratings may remain associated with the subject audio-video clip and, optionally, with the original program—ratings generated for audio-video clips of any given program may be aggregated as a composite rating for the full program. Alternatively, ratings for audio-video clips from a given program can be aggregated with ratings for other audio-video clips from the same program to develop a so-called “audio-video clip rating” associated with the program. In other words, a given program could have a “program rating” as well as a separate audio-video clip rating. Additionally, audio-video clips of a common program can be aggregated so that in some cases, viewers may choose only to watch the aggregate audio-video clips instead of the complete program. Additionally, if the subject program is part of a series of programs, then the ratings could be further aggregated to create a composite series rating, with subscribers able to investigate ratings and comments for the series as a whole, for specific episodes and for specific portions/audio-video clips within those episodes. Such ratings could even be further aggregated to create a rating for a particular network or channel.

Additionally described herein are methods and systems for generating a composite channel that includes content from various television providers and other sources delivered via the Internet or other computer-based networks or via conventional cable (i.e., hybrid fibre coax) or satellite television networks. The present delivery system for television programming provides opportunities for creating composite channels that include content from various television providers and other sources. The sources may be selected by a user and/or may be designated by a service provider. For example, a user could establish a composite channel for “football highlights” which would include such highlights from any subscribed to content source. Or, a content provider could offer such a composite channel which a user could then subscribe to. In the case of the user-defined channel, the user would be provided means for defining the content sources which comprise the composite channel. For example, the user could be provided one or more on-screen menus or wizards through which the user could define the attributes of the composite channel, name the channel, assign a channel number for a custom channel lineup, and define the sources from which content for the channel should be harvested. This definition may be done on a channel-by-channel or provider-by-provider basis, or may be done on the basis of a content category (e.g., sports, news, drama, etc.) as identified by metadata regarding the content item or content source. The service provider defined composite channel could include a description of the attributes, sources, etc. so that a subscriber can determine whether or not he/she wishes to subscribe to the composite channel.

The content sources for the composite channel can be any sources delivered over network 100. For example, television content from any television content provider can be included. So too can content from any Internet source. User-generated content (such as may be available from a community of subscribers) may also be included. The content from these multiple feeds may be presented sequentially (as would be needed for a full-screen view) or simultaneously (e.g., within two or more windows or other screen areas on a television). The individual content items may be clips of other content items or may be complete content items, or any combination of same.

In the case of previously stored content that comprises the composite channel, viewers may use trick mode controls to fast forward, rewind, stop, pause and otherwise control the playback of the content items. Viewers could also skip over content items if so desired. Otherwise, the content items would be played from server 106 one after the other (possibly with interspersed advertising and the like) in a “daisy-chain” fashion.

Viewers are permitted to assign ratings to composite channels and/or to the content elements presented therein. The ratings may remain associated with the subject clips or channels. Content items with higher ratings might be presented more frequently than those with lower ratings and/or may be persisted longer within the composite channel than lower rated content items. Ratings could also include scoring of the relevancy of the content item to the channel description, which would be especially useful in the case where a viewer has subscribed to a composite channel which the viewer did not him/herself construct. Likewise, content items could be assigned ratings according to their suitability for viewing by minors or others.

In addition to ratings, viewers may be permitted to add metadata or tags to content items, and such tags used as indicators for the appropriateness, or not, of adding the tagged content item to other composite channels. For example, a content item originally tagged or classified as “sports” and included in a sport highlight channel could also be tagged as football and automatically added to a football highlights composite channel by server 106. If a content item appears in multiple channels, its associated ratings may be recorded as a composite of the ratings from viewers of the different channels or may be reported separately, per channel.

Another form of composite channel is a “series channel”, which may feature episodes or other content items from a common television or other program. The episodes, etc., may be presented in serial or other fashion, according to the user or service provider defined attributes for the channel. In the case of a current episode, the composite channel may preempt playback of past episodes in favor of real time transmission of the current episode and then revert to previous episodes when the current episode has concluded (or replay the current episode for different time zones, etc.). Such series channels may be offered for no additional fee to subscribers to the network/channel which carries the current episodes (e.g., as an enticement for viewers to subscribe to the network/channel) or may require a separate subscription fee. Of course, any composite channel could mix, combine or aggregate both live/real-time content with stored/recorded/archived material and the series channel example is not intended to limit the use of such composite channels to series programs. While all trick modes would be available for stored or recorded material, fast forwarding past the current time would not be available for live content.

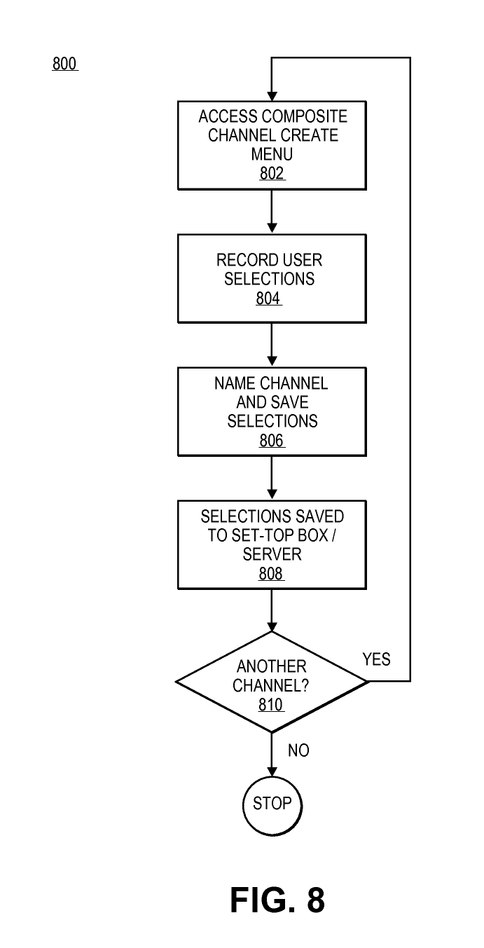

FIG. 8 illustrates an example of a process 800 for generating a user-defined composite channel that includes content from various television providers and other sources delivered via the Internet or other computer-based networks in accordance with an embodiment of the present invention. At 802, the user accesses an appropriate menu or wizard for creating the composite channel. This is preferably an on-screen menu or wizard produced by the set-top box or server 106, based on the user's current subscriptions. That is, the menu or wizard is populated with choices according to the user's current channel subscriptions. Of course, additional channel choices, beyond those available with the user's current subscriptions, may be offered, but the user should preferably be alerted to the possibility of incurring additional subscription fees associated with those choices. Composite channels themselves may incur additional subscription fees.

At 804, the user makes selections for the new composite channel. This may involve selecting channels, programs, genres of content, content descriptors (e.g., to be compared against tags or other metadata), etc. Virtually any content item attribute can be used as a basis for a composite channel and the present invention is not limited to any particular attributes. In some instances, the user selection may involve subscribing to various service feeds, such as popular items of the day/week/etc. or celebrity or sponsor-promulgated composite lists, etc. in fact, the user may create composite channels with an eye towards reducing the user's subscription fee by subscribing to a an advertisement composite channel and agreeing to watch a certain number of advertisements over a defined time period in exchange for subscription fee subsidies. Similarly a ‘revenue sharing’ business model could be created whereby subscription fees for composite channels could be distributed to the owners of such content on the basis of their material's contribution to those composite channels. It should be evident that a number of such distribution models and variants would be possible.

At 806, the user names the new composite channel (although this may be done prior to or during the content selection process) and saves his/her selections. This record may be saved to the set-top box and/or server 808. Composite channel content is preferably assembled at server 106 and provided to the set-top box when the corresponding composite channel is selected for viewing. As part of the naming process, the user may assign the composite channel a custom channel number (regardless of the content sources used to create the composite content) and/or a custom position within a channel lineup in an electronic program guide. Finally, the user is provided an opportunity to create another custom channel or quit the process. 810.

Users may share their user-defined composite channels with other users or groups of users. For example, after a composite channel has been created, the user may be afforded an opportunity to compose a message to one or more recipients. This may be done immediately after creating the composite channel or may be done at a later time convenient to the user. For example, the user may want to create several composite channels and then afterwards compose a composite message for the recipient(s) that covers all of the various composite channels. The message may be composed using a keyboard which is part of the remote control, or is a separate keyboard, or is a soft keyboard that is brought up on-screen and used by manipulating the remote control or other means.

Once the message has been composed, the user sends the message to the recipient(s) by executing an appropriate command via the remote control. The recipient(s) may be selected from an address book or other contact list, much in the same fashion as emails are customarily addressed. The address list may be accessible via an on-screen menu using the remote control.

When the message is sent to the recipient(s), included therein is information sufficient to identify the composite channel. This may include a data structure defining the composite channel and its constituents, or may simply be a reference that can be used by server 106 to identify the channel and its constituents. In either event, the message may be provided to the recipient(s) immediately, via an on-screen notification through the recipients' individual set-top boxes, or may simply be indicated in electronic mailboxes accessible by each recipient. In the latter case, a recipient may be notified of the availability of a new message in his/her mailbox. The electronic mailbox may exist on the server or the recipient's set-top box, or both. The recipient(s) can subscribe to the composite channel by indicating same via their own individual set-top boxes and thereafter may view the associated content by tuning to the composite channel as desired.

Thus, methods and systems for generating a composite channel that includes content from various television providers and other sources delivered via the Internet or other computer-based networks have been described. As indicated above, such composite channels may be created according to user input and direction or automatically, without user intervention. For example, automated search routines running or launched by server 106 may search for content having common attributes or metadata to identify material from which to generate a composite channel. In addition, clips (or segments) from larger content items may be used to form a composite channel. The clips may be user-defined or may be content provider defined (for example in the fashion of trailers for movies and the like). Provided the various clips or segments are individually identifiable (e.g., on the basis of associated metadata or other label or tags, etc.) then such clips may be extracted from the larger content items automatically and used to form part or all of a composite channel.

Further described herein are methods and systems for sharing a content viewing experience among geographically separated users in a network-based content delivery system. The content may be television programming delivered via the Internet or other computer-based networks or via conventional cable (i.e., hybrid fiber coax) or satellite television networks. In one embodiment, the invention provides a digital video recorder (DVR)-like experience for multiple geographically separated users, in that the users all view the same content at the same time, through their own televisions or other content viewing platforms, and one user is provided the ability to control the playback of the content with trick mode style controls (e.g., play, fast-forward, rewind, pause, stop, etc.). Optionally, the users (or a subset thereof) may share text or other comments with one another and such comments may be presented on-screen (overlaid on or adjacent to the content being viewed). Further, in some embodiments, the users may share audio/video feeds (e.g., provided via web cams or the like) with one another (or a subset thereof). In either instance, the effect is one of sharing a viewing experience with others as if they were co-located with one another instead of being geographically dispersed. These and further embodiments of the invention are described below and those of ordinary skill in the art will recognize that the present invention finds applicability to content and/or services delivered to users by a conventional cable or satellite network as well as via the Internet or other computer-based network.

Today, watching television (or content from a digital video disc (DVD), personal video player, or other source) is a “single-point” experience that can be shared only with a group of viewers gathered around the same television set (or other viewing platform). That is, although people in different households (or different rooms of the same house for that matter) may be able to watch the same television program on their individual television sets, the experience remains a solitary or isolated one for those viewers (or groups of viewers) because each watches the program on his/her/their own terms, without interacting with the other viewers (or groups of viewers) at geographically dispersed locations. The present invention overcomes this limitation and allows multiple viewers (or groups of viewers) to share the same viewing experience even if they are located remotely from one another.

As illustrated in FIG. 1, each set-top box—television combination can be regarded as a client of server 106 (in some instances it may be possible to couple multiple televisions or viewing platforms to a single set-top box, but for sake of simplicity and so as not to obscure the present invention, it will be assumed for purposes of the discussion herein that only one such television/viewing platform is connected to each set-top box). As such, and in accordance with the present invention, content may be provided from server 106 to multiple ones of these clients, simultaneously (or nearly so). Playback commands (e.g., play, fast-forward, rewind, pause, stop, etc.) from one client (which may for purposes of a shared viewing experience be considered a “leader” or “organizer”) can be used to control the provision of content to all clients of a designated group because the commands are directed at the playback originating from server 106. Thus, for a group of designated and remotely located clients, a shared viewing experience can be provided under the control of a single leader. The viewing experience may include trick modes and other playback options, to potentially modify the flow of the viewing experience, under the control of the leader or event organizer. In some circumstances, a plurality (from one up to the total number of clients) of leaders might be able to provide such control. Whether such “multi-leader” operation would be desirable, or confusingly annoying, could be left up to the participants. But for sake of simplicity and so as not to obscure the present invention, it will be assumed for purposes of the discussion herein that only one such leader, at any given time, is able to control the shared viewing experience.

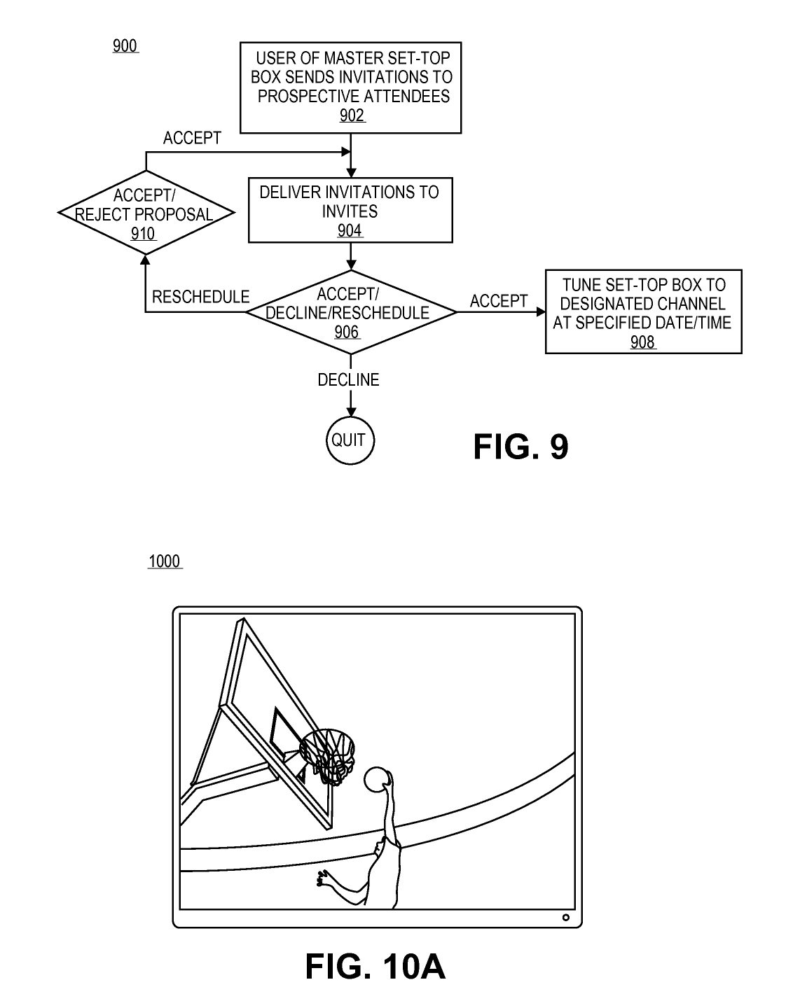

Designating the group of participating clients and the group leader may be accomplished in any of a variety of ways. For example, as shown in process 900 illustrated in FIG. 9, a group of clients for a shared viewing experience could be established with the leader sending invitations to prospective attendees (e.g., friends) 902. In some cases, the shared viewing experience may be a playlist of one or more content items selected by, for example, a group leader or an organizer of a shared viewing experience. The invitations may be distributed in-system via server 106 and through the set-top boxes of the invited participants and may be delivered 904 to the recipient immediately, via an on-screen notification through the recipient's set-top box, or may simply be indicated in an electronic mailbox accessible by the recipient. In the latter case, the recipient may be notified of the availability of a new message in his/her mailbox. The electronic mailbox may exist on the server 106 or the recipient's set-top box 104, or both.

Designating the group of participating clients may also be accomplished by the leader selecting contact information for prospective attendees from, for example, a contact list. In some cases, the contact list may be uploaded to server 106 via downloading a contact list from an external device associated with the leader such as a mobile telephone, a laptop computer, and/or personal digital assistant (PDA) to server 106. In other cases, the contact list may be stored at sever 106. On some occasions, the participating clients may be organized into a community using, for example, the contact information of the respective participating clients or an interest associated with the respective participating clients.

The messages may read as an invitation and specify a date, time and program for the shared viewing experience. Invited participants could accept or decline the invitation 306. For those that decline, the process ends. For those that accept, their set-top boxes would tune to the designated channel on which the program is being presented at the specified date and time 908. Alternatively, instead of automatically tuning to the designated channel, a reminder notice could be presented to an invitee, either on-screen or out of band (e.g., by way of email, instant message, automated phone call, etc.). Further, the reminder notice could be presented on-screen in advance of the scheduled time and the invitee given an opportunity to opt out of the viewing (even though the invitee had previously accepted) within a specified time, otherwise the set-top box will automatically tune to the scheduled channel.

In some embodiments, options could be provided for an invitee to propose scheduling changes if the invitee wants to participate in the event but cannot attend at the proposed date and time. The reschedule proposal would be sent to the leader, who could accept or reject the proposal 910. If the proposal is rejected, the process ends for the subject invitee, but if it is accepted, rescheduling notices are sent to the other invitees. In some cases, invitations may be sent to any users of the present system and not just friends of a user, for example in the case of a promotion where a celebrity, sponsor, promoter, service provider, or other individual (or group of individuals) will “host” a shared viewing experience.

In some instances, it may be the case that an invitee to a shared viewing experience is not a subscriber to the content or channel with which the shared viewing experience is concerned. In such cases, the organizer of the event (i.e., the user that initiates the invitations and will have, at least initially, control over the playing of the content) may be notified at the time the invitations are being created (or sometime thereafter, but prior to the event start date and time) and given the opportunity to purchase viewing rights for that invitee. This may come in the form of a one-time or other pass for the invitee or a complete channel subscription for the invitee. Or, the viewing fee may be charged to the organizer (e.g., to a special account maintained by the organizer for such circumstances or to the organizer's monthly or other periodic bill, etc.). In other cases, when an invitee that does not already have sufficient rights to view the content that is the subject of a shared viewing experience invitation receives the invitation, that invitee may be provided the opportunity to purchase such rights, either through a one-time or other pass or some other form of subscription. The organizer may be notified when the invitee has completed the purchase so that the organizer is aware that the invitee will be able to participate in the event.

As mentioned above, the organizer of the event will be the user that has initial control over the playing of the content during the shared viewing experience. Thus, any playback or other commands delivered by the organizer through his/her set-top will be instantiated not only for the playing of the content through the organizer's set-top box, but also for the content as played through the other participants' set-top boxes. At times during the shared viewing experience, the organizer may cede control of the playing of the content to one of the other participants. This may be accomplished, for example, by executing a “transfer control” or similar command at the organizer's client in conjunction with designating a transferee leader to which control is being ceded. It may also be necessary for the transferee leader to accept control, though this is not necessarily so. In any event, when control is transferred (and, if needed, accepted), the transferee leader will then have the opportunity to control the playing of the content over all of the involved clients. Control may revert to the original leader either by having the transferee leader cede control or by the original leader regaining control without the consent of the transferee leader. Other implementations may involve a different, but functionally equivalent, set of commands.

The exchange of control over the playing of the content as described above is made possible because the server 106 (or a cluster of servers, which may be geographically distributed) is the source of the content (and, hence, may be regarded as a “DVR in the cloud”). Thus, the server can maintain a record of which set-top box has control of the shared viewing experience at any particular time. Further, participants in the experience can request control from the organizer (or transferee leader) by sending an in-band message or other alert requesting same. Control may be transferred accordingly (or not) simply by the organizer (or transferee leader) responding to the request. In other instances, control may rotate on a periodic, random, pseudo-random or other basis among the participants. Alternatively, participants may need to engage in games of chance or skill in order to “win” control from the organizer or the participant having control. When the shared viewing experience is a playlist, control of the viewing experience may remain with the participant, instead of the organizer.

In the case where “live” content is involved (e.g., a live sporting event, concert, news conference, etc.), content providers may place restrictions on shared viewing events. For example, content providers may wish to enforce blackout restrictions, time shifted playback schedules for viewers in different time zones, or other restrictions, that would limit the ability of invitees in different time zones and/or cities/regions to participate in a shared viewing experience. Generally, such restrictions may be identified in metadata or other information associated with the content and would be enforced by server 106 (perhaps unless the organizer or invitee(s) are willing to purchase special viewing rights). The organizer of an event may be informed of such restrictions (e.g., either generally or on an invitee-by-invitee basis) at the time the invitations to the event are being created (or thereafter if the restrictions are not known at the time the invitations are created) and/or each invitee may be so informed. Alternatively, the server 106 may simply block invitations to prospective invitees that would not be eligible to participate in a shared viewing experience as a result of such restrictions. Other examples of restrictions enforced in connection with a shared viewing experience may include prohibitions on trick mode operation (e.g., to preserve the dramatic intent of the content creator, etc.) or time-zone shifted playback of a first airing of a content item.

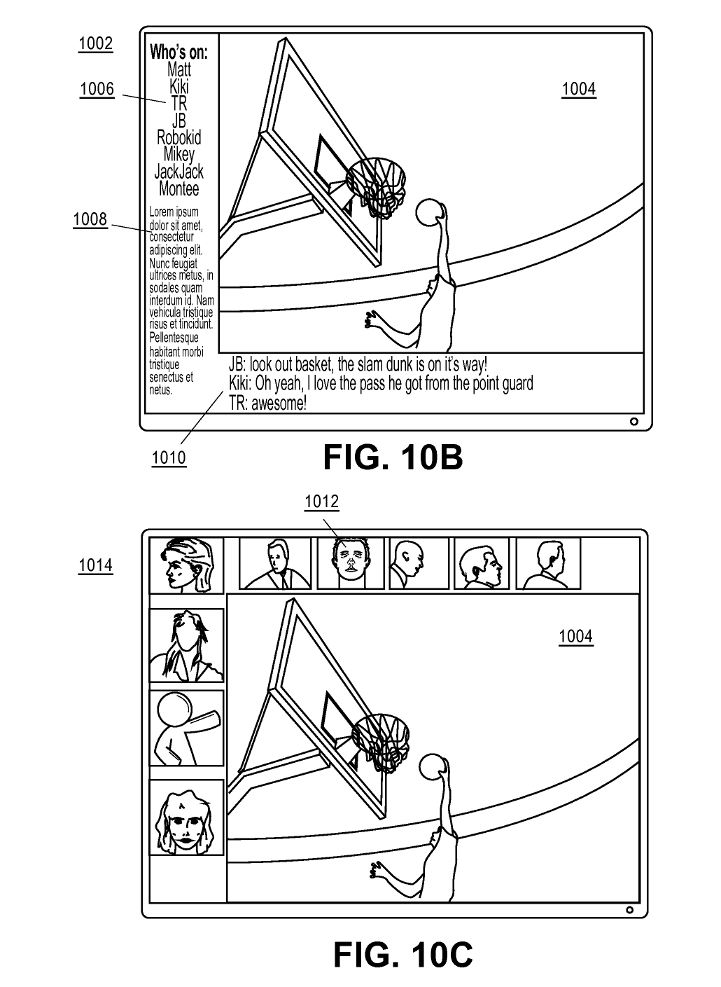

In addition to providing an opportunity for common control over a viewing experience for geographically dispersed viewers, the present invention provides an opportunity for in-band interaction among those viewers. For example, through an exchange of in-system messages, which may be presented as individual messages or as a threaded discussion board or as a bulletin hoard, etc., some or all of the participants in a shared viewing experience may communicate with one another in real time, in the context of the viewing experience. To better understand this statement, refer to FIGS. 10A-10C.

In FIG. 10A, 1000 designates the full screen viewing experience for any of the participants in the event. In this mode, the set-top box renders a full screen presentation of the content which is the subject of the event to a viewer's television or other viewing platform. This may be regarded as the normal viewing mode. However, this normal viewing mode could be enhanced by live audio feeds from some or all of the participants—allowing participants to exchange audible commentary or conversation while viewing the content in normal viewing mode.

In FIG. 10B, the viewing mode has changed to a discussion view 1002. In this view, the content is displayed in a less than full screen area 1004. This may be any portion of the full screen, but preferably retains the same perspective (e.g., 4:3, 16:9, etc.) as the full screen mode. Framing the content viewing area 1004 are one or more of the following: a list of the participants in the shared viewing experience 1006, a running discussion board where text comments of the participants are displayed (scrolling from top to bottom as new comments are received) 1008, a comment composition area where a user can compose a message before posting it to the discussion board) 1010. The positioning of such text message/comment areas on the screen is, of course, arbitrary and other arrangements than those depicted herein may be used (e.g., according to user and/or service provider preference) In FIG. 10C, a live web cam area 1012 is provided (where web cam feeds from one or more of the participants can be presented). The web cam area 1012 is shown in the context of a live discussion mode 1014, where all participants are providing web cam feeds to one another and can engage in live audio-video conversations.

In addition to group discussion boards and/or group web cam feeds, private discussion boards/feeds may be established between subsets of the participants in the shared viewing event, much like such features can be provided between participants in an on-line presentation. This way, subgroups of participants can exchange private messages/web cam feeds with one another and not have their comments, etc., read and/or viewed by the entire group participating the event. This is especially useful for situations more akin to a “broadcast” where members of the public are invited to attend a “screening” hosted by a celebrity or sponsor, and a user wishes to limit his/her active interaction to just friends and not a host of unknown other participants. In some cases, the ability to use private communication boards or channels may be at the discretion and under the control of the leader. Where permitted, private channels may be established by selecting the recipients of a message from a participant list or through other means.

The ability to share text and/or audio-video comments with other, geographically dispersed viewers during a shared viewing event emphasizes the nature of the shared experience. Unlike situations where people in different households watch the same television program and then talk about it the next day, the present invention facilitates real time, in-band discussion among the viewers. Watching television goes from being a solitary, single-point event to a participatory, multi-point event.

Each participant's messages and/or web cam (or other audio-video feeds) are provided from each participant's set-top box, through server 106 (or a server farm, etc.) to the other participants' respective set-top boxes. The messages may be passed in the form of instant messages, emails, or other communication means. In some cases, the server may employ filtering software to screen out inappropriate comments. For example, vulgar language or other material may be redacted from messages or the messages simply blocked by the server before they are passed to other participants. The messages may also be used to request that the leader rewind or pause playback if one participant needs to step away from the viewing experience for a time.

The examples of the relative sizes of the various on-screen areas shown in FIGS. 10B and 10C are merely for illustration purpose. These areas may be resized on a per-client basis or may be allocated for maximum viewing enjoyment. In some cases, text messages could be overlaid over full screen content presentations (in the fashion of captions, for example), but this may detract from the viewing experience and so participants may have the option to prevent such text from being presented. In some cases, the content will be shown in full screen unless a viewer affirmatively elects a different view, while in other cases, the default viewing mode may be the discussion view, etc. In the full screen view, audio comments from the other participants (e.g., as gathered by microphones associated with the set-top boxes or remote controls of the participants) may be shared with the other participants (e.g., in lieu of text comments). Or, text comments may be presented at a set-top box as audio comments when a user is in full screen mode, provided that processing means exist, either in the set-top box or on the network, to perform the required text-to-speech conversion (as is contemplated in an embodiment of the invention). Note that it is also possible to use a microphone to compose text messages if the set-top box or remote control or some means on the network is equipped with a speech-to-text converter (as is contemplated in a further embodiment of the invention).

In some cases, the viewing mode may be established for all participants by the leader. This would ensure that all viewers have a common experience. In other cases, however, viewing modes may be individually controlled by each viewer. This would still allow for the shared experience, but on terms more acceptable to an individual user. For example, a user may want to participate in text messaging, but not video conferencing and so the user may disable his/her web cam and not permit a feed there from to be provided to the other participants.

In some embodiments of the invention, rather than presenting text messages in a conventional line-by-line fashion, the text messages could be presented as a one or more lines in a screen ticker or crawler (e.g., in the fashion of a scrolling ticker-tape at or near the bottom (or elsewhere) of the screen). In some cases, as a message is “retired” from the ticker it may be accumulated to a line-by-line display at a side of the content viewing area. This line-by-line display of messages may be scrollable or sortable, so that older messages can be reviewed. The messages are preferably prefaced by an indication of the author thereof, but this need not necessarily be so.

In addition to comments of the other participants, in some embodiments information other than comments may be provided via the on-screen ticker or text fields. For example, information from news feeds, web logs (blogs), or other feeds (e.g., RSS or other feeds) may be provided in the ticker or text fields. This information may concern the content being viewed (e.g., as gathered from various Internet or other sources) or may be unrelated to same (e.g., in the case of current news headlines and the like displayed while watching a movie). The organizer or another participant may establish feeds for the group of participants so that information of importance to the viewer community is displayed (e.g., sports scores, breaking news, the start of other events, etc.). In this way, the ticker or text field acts as an aggregation point for information collected from a variety of sources (including user-generated content). When the information notification/alert relates to video content then the display may be of an icon or picture-in-picture of that content, instead of text.

On some occasions, data ancillary to the shared view experience (e.g., text, audio, and/or video messages) may be time-stamped with a time of their occurrence relative to, for example, the time of delivery of the content item and/or the run-time of the content item. In this way, the content item or items may be viewed, or reviewed, by an original or new participant at a time other than (generally later than) the originally scheduled time of the playing of the content item or items and the ancillary information may be synchronized with, and played in real-time relative to, the playing of the content item or items. Such an original or new participant, reviewing or viewing at a time other than the originally scheduled playing time, would be able to select amongst all of the allowed viewing options that would have been available to them during the original shared view experience; that is the content item or items plus any associated ancillary data generated during that original shared view experience.

In addition to live or pre-recorded content, the present invention is useful in connection with playlists. Playlists are defined lists of audio/video (or just audio or just video) content items (e.g., television programs (both live and stored), user-generated content, Internet-based content, etc.) selected to run either in sequence or, if a shuffle playlist function is selected, in a random or pseudorandom order. Playlists may comprise content items of a similar genre, from a common channel or content provider, from a common type of channel or content provider, or other user-defined or provider-defined criteria. Some playlists may include content recommendations, ratings, and/or reviews. In accordance with embodiments of the invention, users are able to create playlists, thereby planning viewing schedules in advance of the viewing time. Invitations to participate in playlist viewing may encompass an entire playlist or just portions thereof and different participants may be invited to participate in the viewing experience at different points in the playlist (e.g., a group of one set of friends for the sporting event portion and a group of different friends for the movie portion, etc.).

In the case of playlists as a shared viewing experience, they would be generated in a manner of process 600 illustrated in FIG. 6 and distributed in a manner similar to the process 900 illustrated in FIG. 9. The initiator (group leader) of the process distributes a playlist of various content items to the group of second (participating) clients chosen. The recipients may accept, decline, or propose changes to the playlist in a manner similar to the process 900 illustrated in FIG. 9. The primary difference is that, in the use of a playlist, control of the viewing experience remains in the hands of the recipient and is not ceded to another. When the shared viewing experience is a playlist, the participant may not be required adhere to viewing the one or more content items included in the playlist or in the timing of their delivery. In some instances, a playlist may be distributed for informational purposes where a group of participants might share the planning of shared viewing experiences to be included in a playlist that they will all view in a manner similar to, for example, a book group. Although such playlists might be distributed amongst groups of friends or people with common interests, playlists (perhaps of or generated by, famous personalities) may also be made available to some or all users of a network-based content delivery system on an informational basis, whether freely or for a separate subscription to such playlists. When a participant accepts an invitation including a playlist, the participant may choose to accept the invitation for information purposes only (so that set-top box 104 and/or server 106 of the participant is not configured to play the content items included the playlist) or may choose to incorporate the playlist into the control function of the viewing experience, such that set-top box 104 and/or server 106 may automatically deliver, to the participant's display device, the content specified by the playlist without any need for intervention (i.e. no need to select or change channel etc.). The participant may retain the ability to intervene in the playing of the content items included in the playlist in order to terminate, deviate from, pause, modify, or otherwise the alter the progress of the delivery of the content items automatically under control of the playlist information.

The present invention is also applicable in connection with user-generated content, such as gaming activities. Simultaneous web cam and/or audio feeds may be shared amongst players in a game such as poker, bridge, chess, a board game, etc. Instead of television content, the web cam feed may provide a view of a game board and players could participate with one another without having to be physically present in the same room. In some cases, the game board may be a virtual construct presented by an application running on server 106 (or an affiliated server) and players could interact with one another and the game board (or, more generally, the game environment) through the present system. Likewise, educational seminars or other events could be hosted in the multi-point environment provided by the present invention. In the case of games and the like, spectators could be invited to view the event just as is the case for television or other content.

Thus, methods and systems for sharing a content viewing experience among geographically separated users in a network-based content delivery system have been described.

1. A method of generating a user-defined or system-defined composite channel that includes at least one custom viewing schedule and content from multiple content sources delivered via a computer-based network, comprising:
providing via a client device communicatively coupled to a display device, a composite channel creation menu through which a user is permitted to designate the at least one custom viewing schedule and one or more of the content sources as being contributing content sources for the composite channel, wherein the custom viewing schedule includes content items selected from an electronic program guide (EPG);
receiving through the client device user selections for contribution to the composite channel, said user selections identifying the at least one custom viewing schedule and content attributes or content sources; and
associating the user selections with a custom channel number for identifying the composite channel within a channel lineup presented via the EPG; and saving the user selections and custom channel number association.

2. The method of claim 1, wherein the custom viewing schedule is created by the user and/or by the system, the method further comprising:
aggregating identification information for selected content items into a custom viewing schedule for a viewer or viewers, said content items being selected from the EPG presented in response to user input to the client device and via a display device communicatively coupled to the client device, the custom viewing schedule controlling automated channel selections for the client device; and
saving the custom viewing schedule for later use by the client device in presenting or ensuring the recording of the selected content items in the custom viewing schedule.

3. A method of generating a composite channel that includes at least one custom viewing schedule and content from multiple content sources delivered via a computer-based network, comprising:
locating, on the basis of content attributes or metadata predetermined by a user, the at least one custom viewing schedule and one or more content items for the composite channel, said content items being hosted or provided by any of a number of custom viewing schedule sources and content sources and each custom viewing schedule and content item having one or more of the attributes or metadata associated therewith, wherein the custom viewing schedule includes content items selected from an electronic program guide (EPG);
aggregating the at least one custom viewing schedule and content items as selections for contribution to the composite channel; and
publishing the selections within a composite channel of an EPG for a network delivered content service.

4. The method of claim 3, wherein the custom viewing schedule is created by the user and/or by the system, the method further comprising:
aggregating identification information for selected content items into a custom viewing schedule for a viewer or viewers, said content items being selected the EPG presented in response to user input to a client device and via a display device communicatively coupled to the client device, the custom viewing schedule controlling automated channel selections for the client device; and
saving the custom viewing schedule for later use by the client device in presenting or ensuring the recording of the selected content items in the custom viewing schedule.

5. A method for providing customizable user interface elements for content delivered via a network, the method comprising presenting content choices representing at least one custom viewing schedule and programming and other content available via subscribed-to content providers in an electronic program guide (EPG), characterized in that within the EPG the content choices are arranged in an order according to a user-defined channel lineup customized according to any one or more of: user preference, time of day/day of week, user profile information, user viewing statistics, user community viewing statistics, sponsor or content provider preferences, user identity, parental control preferences, or other user-defined criteria, and/or are organized according to a user-defined channel numbering scheme, wherein the custom viewing schedule includes content items selected from the EPG.

6. The method of claim 5, wherein the custom viewing schedule is created by a user and/or by the system, the method further comprising:
aggregating identification information for selected content items into a custom viewing schedule for a viewer or viewers, said content items being selected from the EPG presented in response to user input to a client device and via a display device communicatively coupled to the client device, the custom viewing schedule controlling automated channel selections for the client device; and
saving the custom viewing schedule for later use by the client device in presenting or ensuring the recording of the selected content items in the custom viewing schedule.
